(19) United States
(12) Patent Application Publication
(10) Pub. No.: US 2009/0235599 A1
(43) Pub. Date: Sep. 24, 2009

(54) Laminated structural insulated panel with perforated foam core and method of making same

(76) Inventors: Maximilian Ware, Union, MS (US); Eric Habben, Coarsegold, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 12/381,924

(22) Filed: Mar. 17, 2009

Related U.S. Application Data
(60) Provisional application No. 61/011,093, filed on Mar. 18, 2008.

(51) Int. Cl. E04C 2/34; B29C 65/00

(52) U.S. Cl. 52/309.9; 52/794.1; 156/307.1

(57) ABSTRACT

A laminated structural insulated panel has an inner or core layer, an outer layer on the opposite facing surfaces of the core layer and an adhesive layer between each surface of the core layer and its respective outer laminate layer. To increase the strength and reduce the likelihood of delamination, the present panel is provided with a plurality of perforations in the surface of the core layer that receives the outer and adhesive layers. Each of the perforations form a chamber that receives a portion of the bonding agent or adhesive utilized for the adhesive layer. The bonding agent or adhesive bonds to the side walls of the chamber to mechanically anchor the outer layer to the interior of the core layer by substantially increasing the bonding surface between the adhesive layer and the core layer. In one embodiment, the core layer is an expanded polystyrene or other rigid foam.

### STATEMENT REGARDING FEDERALLY SPONSORED RESEARCH

This patent application claims priority to U.S. Provisional Patent Application No. 61/011,093 filed Mar. 18, 2008.

### CROSS-REFERENCE TO RELATED APPLICATIONS

None.

### BACKGROUND OF THE INVENTION

A. Field of the Invention

The field of the present invention relates generally to structural insulated panels and methods of manufacturing such panels. In particular, the present invention relates to such panels that have an inner core layer and one or more outer laminate layers. Even more particularly, the present invention relates to such panels that are relatively lightweight yet have enhanced structural strength and insulating properties.

B. Background

Structural panels are utilized in buildings, motor vehicles, fabricated housing, recreational vehicles, cabinets, cases and may other types of structures where a support member or surface is required. Most structural panels are made out of a single piece of material that is selected for its strength and insulating properties in light of the particular application which the panel will be utilized. The panel is sized and configured for that use and, often, joined to one or more other structural support components, such as studs and the like, and positioned adjacent panels to form a wall, floor, ceiling or other surface of the desired size and shape. Panels are often made out of wood, metal, fiberglass and like materials. While a structural panel that is made out of a single material has certain benefits with regard to simplicity, it is well known such panels have certain substantial disadvantages. Depending on the material, these disadvantages may include weight, cost, limitations regarding manufacturing larger sized panels and limited insulating ability (also commonly referred to as their R-value). With regard to housing, particularly prefabricated, mobile homes and/or recreational vehicles, the weight and cost of single material panels is an issue that is of substantial consequence to the overall weight of the system in which the panels are utilized.

Many modern panels are made from laminate materials that utilize a pair of outer laminate layers having an inner core layer sandwiched between the two outer layers that are held together with an adhesive layer between the inner core layer and each of the outer layers. As with panels manufactured out of a single material, the materials for the inner and outer layers are selected for the various characteristics or combinations of characteristics which are important for the application in which the panel will be utilized. One common laminate panel, typically referred to as a structural insulated panel or SIP, has an inner core made out of a material that is selected for its insulating ability and its lower weight and outer laminate layers that are selected for their appearance and durability. As an example, a relatively common material for structural insulated panels has a foam inner core comprising expanded polystyrene, which may be molded or extruded. Expanded polystyrene is a closed-cell material which can be formed into sheets of virtually any desired width, length and thickness. Advantages of expanded polystyrene include having an insulating capability or R-value that is at least two to three times higher than many other materials of the same thickness, having a lower per unit weight than most other materials and being relatively easy and inexpensive to manufacture. Alternatively, the inner core of such panels can be made from plywood, waferboard, polyurethane, gypsum, polyvinylchloride (PVC), particle board and a variety of other materials that provide certain characteristics which may be desired for a particular panel application. The outer laminate layer is usually a very thin film or sheet of wood, plastic, steel, aluminum or cement board, among other possible materials, that is selected to provide the desired aesthetic and/or durability properties.

The standard practice in manufacturing structural insulated panels is to fixedly adhere the outer layer to the inner core by utilizing a bonding agent or adhesive between the two layers. As is well known in the art, the bonding agent or adhesive is selected to adhere to the surface of the outer layer and the inner core to substantially form the materials into a single panel. Most foam inner cores are laminated using a batch process and a press to apply pressure while the bonding agent or adhesive cures. An alternative method is a continuous process that uses a conveying method. In general, the present structural insulated panels and method of manufacturing such panels have many good qualities that have made such panels popular in many types of products.

One problem with the current laminated structural insulated panels is delamination of the outer layer due to a failure of the surface adhesion between the inner core layer and the outer layer or layers. This problem is particularly common for panels that have a foam core, such as those made out of expanded polystyrene or the like. Another factor which is generally considered a limitation of many structural insulated panels is the breaking strength of the panel. What is needed, therefore, is a new laminated structural insulated panel that has much improved resistance to delamination and provides improved breaking-strength characteristics for many types of inner core layer and outer layer materials. The preferred structural insulated panel should be suitable for use with a variety of different core and outer layers and be adaptable for a wide variety of panel uses. The improved structural insulated panel should be particularly configured for use with an expanded polystyrene or like foam inner core layer. Preferably, the structural insulated panel should be able to be made relatively simply and in a cost effective manner. The preferred structural panel should be adaptable for manufacturing into a variety of different sizes, including relatively large panels that can be utilized for walls, floors, ceilings and the like.

### SUMMARY OF THE INVENTION

The laminated structural insulated panel of the present invention solves the problems and provides the benefits identified above. That is to say, the present invention discloses a structural insulated panel which is substantially more resistant to delamination and is stronger than presently available laminate structural insulated panels. The new structural insulated panel of the present invention can be manufactured out of a wide variety of materials for the inner core layer, including expanded polystyrene, rigid polyurethane and like foam materials, and a wide variety of materials for the one or more outer laminate layers. As such, the improved structural insulated panel allows use of laminated panels for a wide variety of uses where a structural panel that has very good insulating properties and is relatively lightweight while being resistant to delamination is of benefit to a structure. In a preferred embodiment of the present invention, the structural insulated panel can be manufactured in a variety of different sizes and configurations, including relatively large panels that can be utilized for walls, floors and ceilings, where a lightweight, strong and insulating panel is desired. The laminated structural insulated panel of the present invention is relatively simple and inexpensive to manufacture.

In a primary embodiment of the present invention, the laminated structural insulated panel generally comprises a core layer having a first outer layer that is affixed to its upper surface with a first adhesive layer comprising a bonding agent disposed therebetween and a second outer layer that is affixed to its lower surface with a second adhesive layer comprising the bonding agent disposed therebetween. The core layer is provided with a plurality of perforations that are spaced generally evenly across the entire upper and lower surfaces. Each of the perforations form a chamber inside the core layer, with each chamber having one or more side walls defined by the core layer. A portion of the bonding agent that makes up the first and second adhesive layers is received inside the chambers at the upper and lower surfaces of the core layer. When the bonding agent is cured, the portion of the bonding agent inside the chambers adheres to the side walls of the chambers to provide mechanical anchors that improve the bonding of the outer layers to their respective core layer surfaces. The side walls of the perforations substantially increase the surface area available for surface adhesion with the bonding agent, thereby increasing the strength of the panel and reducing the likelihood of delamination. In a preferred embodiment, the core layer is made out of expanded polystyrene and the outer layers are made from fiberglass reinforced phenolic resin to provide a strong, insulated panel that is free from degradation, impact resistant and nearly fireproof. Such a panel is particularly useful for structural members, such as walls, ceilings and floors, and for non-weight bearing members where delamination resistance is desired. The core layer can be supplied with the perforations therein or the perforations can be added to the core layer by utilizing a needle roller, punch plate or other devices well known in the art.

Accordingly, one of the primary aspects of the present invention is to provide a laminated structural insulated panel that has the advantages-discussed above and overcomes the disadvantages and limitations associated with presently available laminated structural insulated panels.

It is an important aspect of the present invention to provide a laminated structural insulated panel that has improved delamination resistance and which can support higher loading relative to existing laminated structural insulated panels.

It is an important aspect of the present invention to provide a laminated structural insulated panel that allows the use of materials which are selected for their insulating and strength characteristics without increasing the risk of delamination or reducing the strength of the panel.

It is also an important aspect of the present invention to provide a laminated structural insulated panel having an inner core that can be manufactured out of a wide variety of different materials with an outer layer on the opposing sides of the core layer which can be manufactured out of a wide variety of different materials.

It is also an important aspect of the present invention to provide a laminated structural insulated panel that is particularly configured to have an inner core layer made out of expanded polystyrene, polyurethane or other foam material and at least one outer layer affixed to the core layer in a manner that provides improved delamination resistance and strength properties.

Another important aspect of the present invention is to provide a laminated structural insulated panel that can be manufactured in a variety of different sizes and configurations and which is relatively simple and inexpensive to manufacture.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of a fragmentary portion of a laminated structural insulated panel that is configured according to a preferred embodiment of the present invention showing part of the first outer layer and the first adhesive layer removed to better illustrate the components of the panel;

FIG. 2 is an exploded side perspective view showing the various layers of the laminated structural insulated panel of FIG. 1; and

FIG. 3 is a chart summarizing the preferred embodiments of manufacturing the laminated structural insulated panel of FIG. 1.

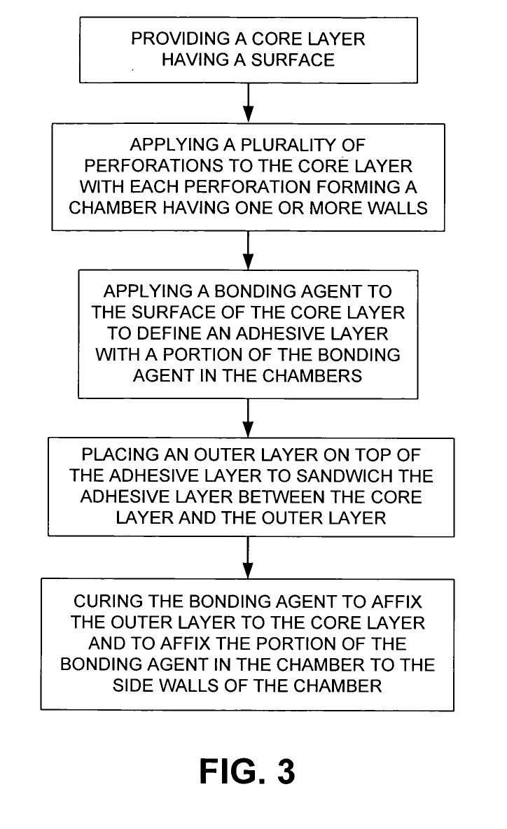

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein show certain materials for the layers of the laminated structural insulated panel, those skilled in the art will readily understand that this is merely for purposes of simplifying the present disclosure and that the present invention is not so limited.

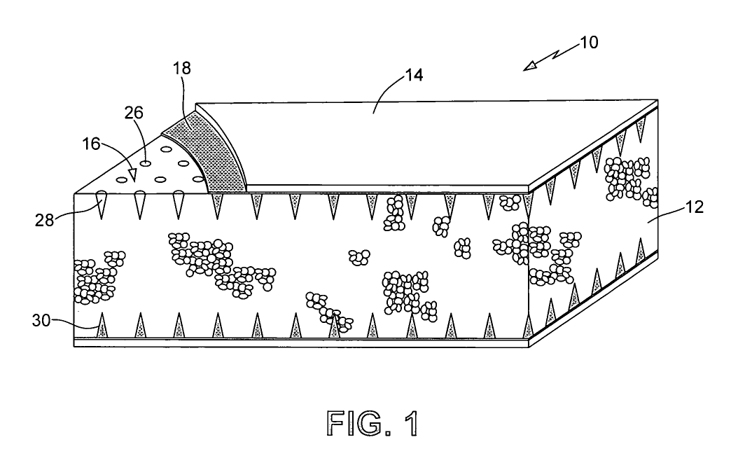

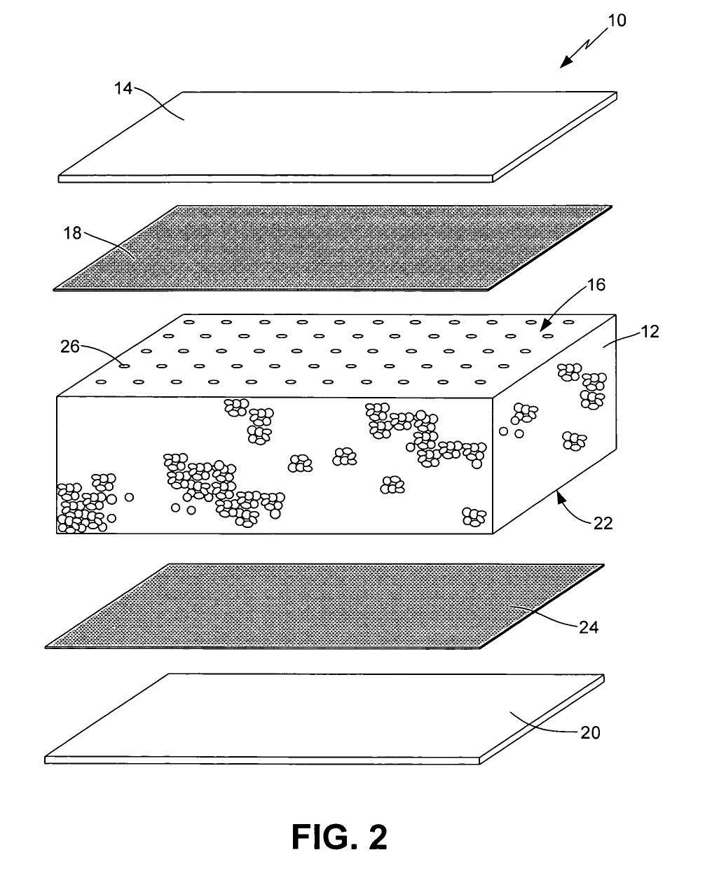

A laminated structural insulated panel that is configured pursuant to a preferred embodiment of the present invention is identified generally as 10 in the figures. The panel 10 generally comprises an inner core or substrate layer 12 that is bounded on one or more of its sides by an outer layer which is fixedly attached to the inner core layer 12 by a thin layer of bonding agent, adhesive or like material (hereinafter collectively referred to as “bonding agent”) chosen for its ability to achieve the necessary surface adhesion between the inner core layer 12 and outer layer(s). In a preferred embodiment, the inner core layer 12 is bounded on one side by a first outer or laminate layer 14 that is affixed to the upper surface 16 of core layer 12 by first adhesive layer 18 and by a second outer or laminate layer 20 that is affixed to the lower surface 22 of core layer 12 by second adhesive layer 24, as shown in FIGS. 1 and 2. The core layer 12 can be made out of a variety of different materials. In a preferred embodiment, however, the material for core layer 12 is chosen for its insulating, structural support and lightweight properties. One such material is expanded polystyrene that can be manufactured according to processes well known in the art to provide the core layer 12 in sheets of virtually any desired width, length and thickness. As set forth above, expanded polystyrene has a higher R-value and less weight than many other panel materials per unit of thickness. A variety of other foam or like materials, including polyurethane, are also believed to be useful for the core layer 12 due to their similar beneficial characteristics. Alternatively, a wide variety of different materials can be used for core layer 12, including but not limited to plywood, particle board, waferboard, polypropylene, gypsum and the like, depending on the desired use and properties for panel 10. As set forth in more detail below, the material for core layer 12 should be generally rigid.

The first 14 and second 20 outer layers can be manufactured out of a wide variety of different materials. If desired, the material chosen for first outer layer 14 can be different than the material chosen for second outer layer 20. In a preferred embodiment, the material for first 14 and second 20 outer layers are chosen for their strength, durability and impact resistant qualities. A preferred material for outer layers 14/20 is fiberglass reinforced phenolic resin due to its ability to be manufactured in relatively thin semi-rigid layers and because it provides a generally durable, impact resistant and near fire-proof surface. One advantage of this material is that the user can “engineer” the outer layers 14/20 to make any strength needed by selecting the fiberglass weave and thickness. In general, the preferred materials for outer layers 14/20 are those which can be relatively inexpensively provided in relatively thin, semi-rigid layers at virtually any size and configuration, such as the fiberglass reinforced phenolic resin. Other materials which may be utilized for outer layers 14/20 include thin semi-rigid films or sheets of wood, plastic, steel, aluminum or cement board, among various other materials, selected to provide the desired aesthetic and/or durability properties for panel 10.

The bonding agent for adhesive layers 18 and 24 are selected to provide the desired surface cohesion between first outer layer 14 and the upper surface 16 of core layer 12 and between second outer layer 20 and the lower surface 22 of core layer 12 to form a substantially unified panel 10. The adhesive layers 18/24 are applied to the surfaces 16/22 of core layer 12 utilizing processes well known in the art. Although the adhesive layers 18/24 may be applied by hand tools, in the preferred embodiment of manufacturing panel 10 the adhesive layers 18/24 are applied by feeding the core layer 12 into an adhesive spreader machine to apply a generally even coat of bonding agent, typically only a few mils thick, onto the upper 16 and lower 22 surfaces of core layer 12. Alternatively, the adhesive layers 18/24 may be applied by spraying or other means. The outer layers 14 and 20 are applied over the adhesive layers 18/24 using a batch process where a press is utilized to apply pressure onto the outer layers 14/20 while the bonding agent cures. Alternatively, a continuous laminate process employing a conveying means can be utilized to apply adhesive layers 18/24 to the surfaces 16/22 of core layer 12.

To improve the strength of panel 10 and reduce the likelihood of delamination, the panel 10 of the present invention comprises a plurality of perforations 26 disposed in the surfaces 16 and 22 of core layer 12 on which an outer layer 14/20 will be applied, as shown in FIGS. 1 and 2. As best shown in FIG. 1, each of the perforations 26 in surfaces 16/22 form a relatively small chamber 28, having one or more side walls 30 defined by core layer 12, inside core layer 12 that receives a portion of the bonding agent that forms the adhesive layer 18/24 that is applied to the surface 16/22 that has the perforations 26. Preferably, the perforations 26 on the surfaces 16/22 are small diameter holes that are spread generally evenly across the entire surface 16 and/or 22 that is to be affixed with an outer layer 14 or 20, respectively. A portion of the bonding agent that defines adhesive layers 18/24 will flow into the chambers 28 formed by perforations 26, thereby allowing the bonding agent or adhesive to penetrate the surfaces 18/24 of core layer 12 and become affixed to the side walls 30 of each of each chamber 28. The resulting effect of perforations 26 and their associated chambers 28 is to substantially increase the total surface area available to the bonding agent and, therefore, provide a much stronger bond between the core layer 12 and the adhesive layers 18 and 24. Once the bonding agent has cured, the material in chambers 28 will form a plurality of shafts of bonding agent that function as mechanical fasteners which anchor the adhesive layers 18/24, and therefore the associated outer layers 14/20, to core layer 12, thereby substantially increasing the strength of the resulting panel 10. With the increased insulating properties of the core layer 12, particular when expanded polystyrene of the like is used, the panel 10 becomes a strong, lightweight and insulated product that can be used in many types of applications, including buildings, vehicles, mobile homes and prefabricated structures.

The perforations 26 can be applied by various processes that are well known in the art, such as by a needle roller (known as “needling”), which is a roller having a plurality of small spikes extending from the roller that is rolled over the upper surface 16 or lower surface 22 of core layer 12 on which the outer layer 14/20 will be applied, or by a punch plate, which has a plurality of small spikes extending outward from the plate that is pressed against the surface 16/22 of core layer 12. Other means for applying the perforations 16 and chambers 28 may also be utilized. The spikes on the roller or plate are sized, configured and spaced to form the perforations 26 and chambers 28 having a desired diameter, depth, angle and spatial arrangement on the surfaces 16/22 of core layer 12. The size and configuration of perforations 26 and chambers 28 are selected based upon the type and density of the core layer 12, the rigidity or elasticity of the bonding agent and the rigidity of outer layer 14/20 to be affixed to core layer 12. Generally, the chambers 28 must be deep enough to provide the desired anchoring but not so deep as to substantially lessen the strength of the core layer 12. In addition, the perforations 26 must not be spaced too close together or be too large that could result in much easier breakage of the core layer 12 yet close enough to provide sufficient anchoring of the outer layers 14/20 across the width and length of core layer 12. The shape of the chamber 28, such as whether pointed (as shown), or blunt-ended must be considered. Each panel 10 must be evaluated based on the above and other factors to determine the most beneficial size and configuration of the perforations 26 and chambers 28 for the materials utilized and the desired use of panel 10. Due to the nature of the anchoring achieved by the use of the plurality of chambers 28 filled with bonding agent, the core layer 12 must be substantially rigid to provide the mechanical connection between the adhesive layers 18/24 and the core layer 12, particularly when expanded polystyrene or other foam materials are utilized for core layer 12. Use of the present method is not intended for a flexible foam core layer 12.

In a preferred embodiment of the present invention, the outer layers 14/20 are applied to the core layer 12 utilizing a “wet lay-up” process whereby the outer layer 14 and/or 20 is saturated with a liquid resin and then is applied to the surface 16 and/or 22, as applicable, to form the adhesive layers 18/24. If desired, the outer layers 14/20 and the resin chosen for the adhesive layers 18/24 can be selected so as to form outer layers 14/20 and adhesive layers 18/24 together. As an example, with the use of a fiberglass reinforced phenolic resin material for the outer layers 14/20, an appropriate resin can be chosen as the bonding agent to cooperatively and jointly cure the bonding agent and the outer layers 14/20. Other types of materials can also be used to cooperatively form the outer layers 14/20 and adhesive layers 18/24. The resin utilized in such a wet lay-up process can be a reinforced or an un-reinforced liquid thermoset resin or polymer-based coating applied directly to the core layer 12 having perforations 26 and chambers 28 on surfaces 16/22.

Use of the perforations 26 and chambers 28 to increase the bonding surface of core layer 12 results in a panel 10 that is approximately 25% stronger and much less likely to suffer from delamination than panels that do not utilize the needled/perforated surfaces 16/22 of core layer 12. The need for a stronger bond between the outer layers 14/20 and the core layer 12 has grown as the performance requirements for structural insulated panels have risen. The original oriented strand board (OSB) wood laminates are frequently being avoided by those in the industry because of problems with rot and mold. More modern, often man-made, laminate materials for outer layers 14/20 are usually less rigid (but still semi-rigid), but they would generally benefit from the increased bonding ability that results from the present invention so as to comply with more stringent codes and warranty issues. In general, a thin flexible outer layer 14/20 will not affix as well as a thin semi-rigid outer layer 14/20. If desired, panel 10 can be manufactured so as to perform structurally up to a given load value or the panel 10 may be manufactured to be a non-structural or non-load bearing component. In either configuration, panel 10 of the present invention is much less likely to have delamination problems relative to the prior art structural insulated panels that do not utilize perforations 26 and chambers 28. The process of forming the perforations 26 and chambers 28 on core layer 12 can be simply and relatively inexpensively added to any existing foam, or other type, core laminating production line with the addition of a needle roller, punch plate or the like.

To manufacture panel 10, the user first provides a core layer 12 that has the desired insulating and structural characteristics for the product with which panel 10 will be utilized. The core layer 12 can be made of virtually any material utilized in currently available structural insulated panels or materials that are not currently utilized for such panels. A plurality of perforations 26 are applied to the upper 16 and/or lower 22 surfaces of core layer 12 to form chambers 28 in the core layer 12 in the desired size, configuration and spatial pattern to achieve the desired bonding between the core layer 12 and the selected bonding agent. A needle roller, punch plate or other devices can be utilized to provide the desired perforations 26 and chambers 28. In one process, the bonding agent is applied to the surfaces 16 and/or 22 of core layer 12 to form adhesive layers 18 and/or 24, with the bonding agent flowing into the chambers 28 through the perforations 26, and the outer layers 14 and/or 20 are applied and pressed onto the adhesive layers 18/24. In another process, likely a preferred process (depending on the materials) of wet lay-up, the outer layers 14 and/or 20 are saturated with a liquid resin and then applied to the perforated core layer 12. In either process, the bonding agent is cured, thereby allowing the adhesive layers 18/24 to bond to the side walls 30 of the chambers 28 to anchor the outer layers 14/20 to the core layer 12. This anchoring effect increases the strength of panel 10 and provides a laminated panel 10 that is much more resistant to delamination. Because panel 10 can be made utilizing many of the same materials and equipment utilized to make existing structural insulated panels, the manufacture of panel 10 is relatively simple and inexpensive.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to various modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A structural insulated panel, comprising:
a core layer having a surface with a plurality of perforations thereon, each of said perforations forming a chamber having one or more side walls defined by said core layer;
an outer layer on said surface of said core layer; and
an adhesive layer disposed between said surface of said core layer and said outer layer, said adhesive layer comprising a bonding agent selected to affix said outer layer to said surface of said core layer, a portion of said bonding agent received inside said chamber and affixed to said side walls of said chamber so as to anchor said outer layer to said surface of said core layer.

2. The structural insulated panel according to claim 1, wherein said perforations are disposed substantially entirely across said surface of said core layer.

3. The structural insulated panel according to claim 1, wherein said core layer is a rigid foam material.

4. The structural insulated panel according to claim 3, wherein said core layer is expanded polystyrene.

5. The structural insulated panel according to claim 1, wherein said panel further comprises a first outer layer disposed over an upper surface of said core layer with a first adhesive layer disposed therebetween and a second outer layer disposed over a lower surface with a second adhesive layer disposed therebetween, each of said upper surface and said lower surface having said perforations.

6. The structural insulated panel according to claim 1, wherein said outer layer is a generally thin semi-rigid material.

7. A structural insulated panel, comprising:
a core layer having an upper surface and a lower surface, each of said upper surface and said lower surface comprising a plurality of perforations disposed substantially entirely across each of said upper surface and said lower surface, each of said perforations forming a chamber having one or more side walls defined by said core layer;
a first outer layer on said upper surface of said core layer;
a first adhesive layer disposed between said upper surface and said first outer layer, said first adhesive layer comprising a bonding agent selected to affix said first outer layer to said upper surface of said core layer, a portion of said bonding agent received inside each of said chambers in said upper surface of said core layer and affixed to said side walls thereof so as to anchor said first outer layer to said upper surface;
a second outer layer on said lower surface of said core layer; and
a second adhesive layer disposed between said lower surface and said second outer layer, said second adhesive layer comprising-a bonding agent selected to affix said second outer layer to said lower surface of said core layer, a portion of said bonding agent received inside each of said chambers in said lower surface of said core layer and affixed to said side walls thereof so as to anchor said second outer layer to said lower surface.

8. The structural insulated panel according to claim 7, wherein said core layer is a rigid foam material.

9. The structural insulated panel according to claim 8, wherein said core layer is expanded polystyrene.

10. The structural insulated panel according to claim 7, wherein said outer layer is a generally thin semi-rigid material.

11. A method of manufacturing a structural insulated panel, said method comprising the steps of:
(a) providing a core layer having a surface;
(b) applying a plurality of perforations to said surface of said core layer, each of said perforations forming a chamber having one or more side walls defined by said core layer;
(c) applying a bonding agent to said surface of said core layer to form an adhesive layer, a portion of said bonding agent being received in each of said chambers in said core layer;
(d) placing an outer layer on said adhesive layer so as to sandwich said adhesive layer between said core layer and said outer layer; and
(e) curing said bonding agent so as to affix said outer layer to said core layer with said portion of said bonding agent in each of said chambers being affixed to the side walls of said chambers so as to anchor said outer layer to said surface of said core layer.

12. The method according to claim 11, wherein said perforations are disposed substantially entirely across said surface of said core layer.

13. The method according to claim 11, wherein said core layer is a rigid foam material.

14. The method according to claim 13, wherein said core layer is expanded polystyrene.

15. The method according to claim 11, wherein said outer layer is a generally thin semi-rigid material.

16. The method according to claim 11, wherein said bonding agent applying step and said outer layer placing step are performed together utilizing a wet lay-up procedure.

17. The method according to claim 16, wherein said core layer is expanded polystyrene and said outer layer is fiberglass reinforced phenolic resin.

18. The method according to claim 17, wherein said curing step jointly cures said outer layer and said bonding agent.
